(19) United States
(12) Patent Application Publication
(10) Pub. No.: US 2026/0187511 A1
(43) Pub. Date: Jul. 2, 2026

(54) QUANTUM COMMUNICATION CHANNELS

(71) Applicant: Mellanox Technologies, Ltd., Yokneam (IL)

(72) Inventors: Elad Mentovich, Tel Aviv (IL); Yuval Idan, Resion Le Zion (IL); Juan Jose Vegas Olmos, Solrød Strand (DK); Eitan Zahavi, Zichron Yaakov (IL); Lina Calavres Zarbiv, Petach Tikva (IL)

(21) Appl. No.: 19/006,024

(22) Filed: Dec. 30, 2024

(51) Int. Cl. G06N 10/40; G06N 10/20; G06N 10/60

(52) U.S. Cl. CPC G06N 10/40; G06N 10/20; G06N 10/60

(57) ABSTRACT

Systems and methods are described that can obtain at least a first quantum measurement associated with a qubit determined based on a first set of parameter values, and a second quantum measurement associated with the qubit determined based on a second set of parameter values and cause a ground state associated with the qubit to be estimated based on at least the first quantum measurement, the second quantum measurement, and at least one relationship between at least the first set of parameter values and the second set of parameter values.

### TECHNICAL FIELD

The present application generally relates to quantum computing, and more particularly to implementing quantum communication channels.

### BACKGROUND

Quantum metrology and computing networks can leverage the laws of quantum mechanics, such as superposition, entanglement, and so on, to perform measurements of physical systems, process measurements of physical systems, and perform computations.

In quantum computing, a quantum circuit can include hardware and/or software for quantum computation, in which a quantum computation is a sequence of quantum (logic) gates, quantum measurements, etc. A quantum circuit can be designed such that the horizontal axis is time, conventionally from left to right, single horizontal lines are quantum bits (“qubits”), double lines are classical bits, and objects connected by these lines define operations performed on the qubits (e.g., measurements or gates). A quantum gate refers to a quantum circuit that operates on some number of qubits. Quantum gates are building blocks of quantum circuits, similar to classical logic gates for classical circuits. Quantum gates are operators that can be represented by matrices corresponding to an orthonormal basis. For example, a quantum gate can be a unitary operator represented by a unitary matrix. Examples of quantum gates includes the identity gate, the Pauli gates (e.g., Pauli-X, Pauli-Y and Pauli-Z), the controlled gates, the Hadamard gate, the phase shift gates, the swap gate, the Toffoli gate, etc. A quantum circuit can be constructed based on a set of parameter values (e.g., a vector of parameter values), θ={θ₁, θ₂, . . . θₙ}, to create a wavefunction (e.g., |ψ(θ) [symbol] ). For example, the set of parameter values can include a set of rotation angles that define the rotation of a qubit around axes (e.g., X, Y and Z axes). More specifically, a set of parameter values can define parameters of quantum gates used to construct parameterized gates of the quantum circuit. For example, a wavefunction with n qubits can be represented by |ψ(θ) [symbol] =|0)^{⊗n}, where |0 [symbol] represents the “0” state, and the symbol ⊗ represents the tensor product. The other state can be the “1” state, represented by |1 [symbol] .

### BRIEF DESCRIPTION OF THE DRAWINGS

FIG. 1 is a diagram of an example system including at least one quantum computer that can be used to implement quantum communication protocols, in accordance with at least one embodiment;

FIG. 2 is a diagram of example system including multiple quantum computers that can be used to implement quantum communication protocols, in accordance with at least one embodiment;

FIGS. 3A-3B are diagrams of example quantum communication protocol (QCP) facilitation components that can be used to implement quantum communication protocols, in accordance with at least one embodiment;

FIG. 4 is a timing diagram illustrating an example method of implementing a quantum communication protocol, in accordance with at least one embodiment;

FIGS. 5-6 are flow diagram of example methods of implementing quantum communication protocols, in accordance with at least one embodiment;

FIGS. 7-8 illustrate a network architecture, in accordance with at least one embodiment;

FIG. 9 illustrates a distributed system, in accordance with at least one embodiment;

FIG. 10 illustrates an exemplary datacenter, in accordance with at least one embodiment;

FIG. 11 illustrates a client-server network, in accordance with at least one embodiment;

FIG. 12 illustrates a computer network, in accordance with at least one embodiment

FIG. 13A illustrates a networked computer system, in accordance with at least one embodiment;

FIG. 13B illustrates a networked computer system, in accordance with at least one embodiment; and

FIG. 13C illustrates a networked computer system, in accordance with at least one embodiment.

### DETAILED DESCRIPTION

Some quantum computers are noisy. Such noise can negatively impact the accuracy of computations performed by quantum computers. For example, noise can lead to errors with respect to an observable (e.g., energy) of a quantum system measured by a quantum circuit implemented by a quantum computer. When noise occurs, it can cause information loss, cause qubits to be incorrectly manipulated during a quantum logic operation (e.g., rotate by the wrong amount), etc. The loss of quantum information over time can include decoherence. This can lead to the final state determined by the quantum circuit being different from the intended final state.

To address this, a hybrid quantum-classical system can include a quantum computing side and a classical computing side. The quantum computing side can include at least one quantum computer implementing at least one quantum circuit. The quantum computer can be configured for addressing quantum tasks-such as quantum search algorithms and/or quantum machine learning algorithms. The classical computing side can include at least one classical computer. For example, the at least one classical computer can include a high-performance computer (HPC) or supercomputer. The at least one classical computer can be configured for addressing fundamental classical tasks-such as quantum search algorithms and/or quantum machine learning algorithms.

For example, the hybrid quantum-classical system can implement a hybrid quantum-classical method that can be used to minimize error (e.g., reduce noise) with respect to a quantum measurement made by a quantum circuit implemented by a quantum computer. More specifically, a hybrid quantum-classical method can be used to identify a set of parameter values that corresponds to the ground state of a quantum system with respect to an observable of the quantum system. In at least one embodiment, the observable is the energy of the quantum system, and the ground state of a quantum system is the ground state energy of the quantum system (e.g., the lowest energy state of the system). More specifically, the energy of the quantum system can be the Hamiltonian representing the total energy of the quantum (e.g., the sum of the kinetic energy and the potential energy of the quantum system), and the ground state energy can be the ground state of energy of the Hamiltonian of the quantum system.

The hybrid quantum-classical method can use an iterative process to identify a set of parameter values for constructing a quantum circuit that can generate the ground state energy. For example, an initial quantum circuit to be implemented by a quantum computer of the quantum computing side can be constructed based on a set of initial parameters. The initial quantum circuit, also referred to as an ansatz quantum circuit (or simply “ansatz”), represents a trial wavefunction. The initial quantum circuit can be selected or designed with any suitable set of initial parameters. The initial quantum circuit can be constructed by a user based on domain knowledge.

After constructing the initial quantum circuit, the initial quantum circuit can be implemented to prepare a quantum state associated with a qubit (e.g., corresponding to the wavefunction |ψ(θ) [symbol] ). In at least one embodiment, a quantum state includes a spin state of a particle. In at least one embodiment, a spin state is spin up. In at least one embodiment, a spin state is spin down. In at least one embodiment, a quantum state includes a polarization state. In at least one embodiment, a polarization state is a photon polarization state. In at least one embodiment, a polarization state is a vertical polarization state. In at least one embodiment a polarization state is a horizontal polarization state. In at least one embodiment, a polarization state is a linear polarization state. In at least one embodiment, a polarization state is a circular polarization state. In at least one embodiment, a quantum state is defined by a superposition state of each possible quantum state of a set of possible quantum states. In at least one embodiment, a set of possible quantum states is a pair of possible quantum states, and a set of basis states is a pair of basis states. In at least one embodiment, a quantum state is a linear superposition of a set of basis states. In at least one embodiment, a set of basis states is a set of orthonormal basis states. In at least one embodiment, a set of basis states is represented by a set of basis vectors. In at least one embodiment, a basis state is a linear combination of a set of basis vectors, where each basis vector is multiplied by a respective scalar value. In at least one embodiment, each scalar value is a respective probability amplitude. In at least one embodiment, each scalar value is a complex number. In at least one embodiment, a quantum state is a pure quantum state corresponding to a coherent superposition state. In at least one embodiment, a quantum state is a mixed quantum state defined by a probabilistic combination of a plurality of pure quantum states. In at least one embodiment, a quantum state is represented by a density matrix. In at least one embodiment, a quantum state is a pure quantum state if a corresponding density matrix has a trace equal to one. In at least one embodiment, a quantum state is a mixed quantum state if a corresponding density matrix has a trace not equal to one. In at least one embodiment, quantum error correction is applied to recover a pure quantum state from a mixed quantum state. In at least one embodiment, quantum error correction includes encoding a quantum state onto multiple qubits. In at least one embodiment, quantum error correction includes encoding a quantum state onto multiple entangled qubits.

In the example of finding the ground state energy of the quantum system, a quantum measurement associated with a qubit can be obtained by measuring the expectation values of the Hamilton. Measuring the expectation values of the Hamiltonian can be achieved by implementing the quantum circuit multiple times. For example, the Hamiltonian of the quantum system, Ĥ, can be expressed as the sum of Pauli operators Ĥ=Σᵢ cᵢPᵢ, where cᵢ are coefficients and Pᵢ are the tensor products of Pauli matrices. In this example, the quantum circuit can be implemented with respect to each Pᵢ (e.g., [symbol] ψ(θ) [symbol] ψ(θ) [symbol] =Σᵢcᵢ [symbol] ψ(θ)|Pᵢ|ψ(θ) [symbol] ).

After the initial quantum circuit is implemented to obtain an initial quantum measurement, the quantum measurement can be used to determine the energy of the quantum system as a function of a set of parameters, referred to as E(θ). A classical computer can perform an optimization method to identify a set of updated parameter values that, when used to construct the quantum circuit, can minimize E(θ). More specifically, E(θ) can be an objective function or a loss function, and the set of updated parameter values can be a set of parameter values that are determined to result in a minimum of E(θ) (e.g., a global or absolute minimum). Any suitable optimization method can be used to identify the set of updated parameter values. Examples of optimization methods include gradient descent, constrained optimization methods, Bayesian optimization methods, Nelder-Mead, etc.

The set of updated parameter values can be used to construct a quantum circuit that, when implemented by the quantum computer, can be used to determine an updated quantum measurement (e.g., updated energy) associated with a qubit. That is, the set of parameter values used to construct a quantum circuit can be tunable. In at least one embodiment, each unique set of parameter values may be used to construct a different quantum circuit associated with a same qubit. A classical computer can then perform another optimization method to identify another set of updated parameter values that minimize the updated quantum measurement.

Iterative loops of a quantum computer implementing a quantum circuit constructed based on a set of parameter values to generate a quantum measurement, and a classical computer performing an optimization method to identify a set of parameter values based on the quantum measurement, can continue until convergence is reached (e.g., the optimization method converges to the ground state energy of the quantum system), or until the accuracy of the result satisfies a threshold condition (e.g., a target level of accuracy is achieved). More specifically, the lowest value found during the optimization method can correspond to the ground state (e.g., ground state energy) of the quantum system. The set of parameter values determined to result in the lowest value can be a final set of parameter values that can be used to construct the quantum circuit.

One example of a hybrid quantum-classical method described above is the variational quantum eigensolver (VQE). The term “variational” refers to the variational principle of quantum mechanics, which states that the ground state energy of a quantum system is the lowest possible energy that can be achieved by a system's state. The variational principle can be used to estimate this ground state by testing out different candidate states and selecting the one that gives the lowest energy. Generally, the term “eigensolver” refers to a method that solves for eigenvalues of an eigenvector of a linear transformation when applied to the eigenvector. In the VQE example, an eigenvalue can represent an energy level after a Hamiltonian operator is applied to an eigenvector defining the quantum state |ω(θ) [symbol] . VQE is a method that can use a [symbol] parameterized quantum circuit to approximate eigenstates of an observable (e.g., the Hamiltonian). By iteratively adjusting the set of parameters and minimizing the quantum measurement (e.g., energy) using a classical computer as described above, VQE can be used to identify the ground quantum state as the quantum state with smallest or ground state eigenvalue (e.g., smallest energy value that the quantum system can have).

Typically, hybrid quantum-classical methods described above are performed using a quantum measurement made by a single quantum computer implementing a quantum circuit, and a single classical computer performs the optimization method based on the quantum measurement. However, there are various challenges with implementing such hybrid quantum-classical methods in this way. For example, the choice of the initial quantum circuit, or ansatz, can affect convergence rates and/or accuracy of results, as poor initial quantum circuit choices can cause slow converge, or convergence toward local minima of the objective or loss function (e.g., energy) instead of absolute minima of the objective or loss function. Additionally, the number of iterations of adjusting parameter values for updated quantum circuits and testing such updated quantum circuits using traditional hybrid quantum-classical methods can be high. This results in the expenditure of increased computations, increased bandwidth utilization and increased time as compared to embodiments described herein.

Embodiments described herein can address these and other drawbacks by implementing quantum communication channels that can implement a collective communication protocol for quantum metrology. Embodiments described herein can be used to accelerate computations made by a hybrid quantum-classical system implementing a hybrid quantum-classical method. A hybrid quantum-classical system described herein can include one or more quantum computers, multiple (e.g., at least two) classical computers (e.g., HPCs), and a quantum communication protocol (QCP) facilitation component that can be used to send multiple quantum measurements determined by multiple quantum circuits, implemented by the one or more quantum computers, to the multiple classical computers. In embodiments, multiple quantum circuits may generate respective measurements of a qubit, and multiple quantum measurements may be performed by multiple respective classical computers (e.g., HPCs) to determine multiple sets of updated parameter values. For example, multiple quantum circuits may generate respective measurements of a qubit, and multiple quantum measurements may be performed by multiple respective HPCs to determine multiple respective sets of updated parameter values. In at least one embodiment, the QCP facilitation component includes a network interface controller (NIC). In at least one embodiment, the NIC is a “smart” NIC that includes a data processing unit (DPU).

The QCP facilitation component can be used to establish a rapid interconnect link between the quantum computer and the classical computer(s), enhancing overall performance. The QCP facilitation component can simultaneously (or near-simultaneously) maintain quantum state information about all observed quantum states. The QCP facilitation component can further perform comparison and/or benchmarking using the quantum state information. The particular computational role of the QCP facilitation component can depend on the particular hybrid quantum-classical method being performed.

For example, a set of parameter values of the quantum circuit (e.g., rotation angle parameters) can be stored in classical registers for transmission via the QCP facilitation component. The set of parameter values can be organized in at least one string s. These strings, along with the quantum measurements, can be updated via the classical computers. The updated strings may be provided to the QCP facilitation component from the multiple classical computers, which may then compare the multiple strings and optionally generate updated strings based on a result of the comparison or determine that the multiple strings match (or are close to matching) and accurately represent a state of a qubit. This updated data (e.g., updated parameter values) can then be fed back into the quantum computer to facilitate further measurements of the qubit via one or more updated quantum circuits, to implement the hybrid quantum-classical method.

A quantum circuit described herein can be used to generate a local quantum measurement or a global quantum measurement. A global quantum measurement is a measurement of an entire quantum system as a single quantum state, whereas a local quantum measurement is a measurement of the quantum state of each qubit of a quantum system. Thus, local quantum measurements can enable each qubit to be measured separately.

A quantum computer is configured to perform one or more operations associated with a quantum algorithm. In some embodiments, each of the one or more quantum computers may include a plurality of qubits and the one or more quantum computers may be in communication with each other via a quantum channel (and in some embodiments, a classical channel). In some embodiments, each of the plurality of qubits may include local correlated qubits, global correlated qubits, and/or synchronization qubits. In some embodiments, the local qubits of each quantum computer may be configured to perform the one or more operations associated with the quantum algorithm on the quantum computer that the local qubits are associated with. A quantum measurement can be stored by the QCP facilitation component in classical memory (e.g., a classical register). In at least one embodiment, a quantum measurement is stored in a string.

In at least one embodiment, implementing the collective communication protocol includes the QCP facilitation component facilitating the performance of a hybrid quantum-classical method performed in parallel based on multiple initial states |ψᵢ(θ) [symbol] . These embodiments can address one ore more drawbacks of typical implementations of hybrid quantum-classical methods, such as the risk of an optimization method performed by a single classical computer converging to a local minimum rather than the global minimum. The QCP facilitation component can be used to facilitate parallel optimization on numerous wavefunctions, which can expedite the computation by identifying lower points in the Rayleigh ratio

$$( e . g . , ϵ = \frac{\int 〈 ψ ( θ ) \vert H \vert ψ ( θ ) 〉 dt}{\int 〈 ψ ( θ ) \vert ψ ( θ ) 〉} ) .$$

These embodiments can be used to evaluate the evolution of wavefunctions under various channels, and can aid in error correction, wave function evaluation via tomography, and other advanced applications.

For example, in at least one embodiment, implementing the collective communication protocol includes the QCP facilitation component obtaining, from one or more quantum computers, multiple quantum measurements of an observable associated with a qubit determined by multiple quantum circuits implemented by the at least one quantum computer. In at least one embodiment, multiple quantum computers are used to generate respective measurements, and the collective communication protocol is performed to determine whether the quantum computers meet design tolerances based on similarities between the respective quantum measurements and/or optimized sets of parameters determined from the respective quantum measurements.

More specifically, each quantum circuit can be an initial quantum circuit (e.g., ansatz) that is constructed (e.g., parameterized) based on a unique respective set of initial parameter values. In at least one embodiment, each set of initial parameter values includes a set of rotation angles. For example, each rotation angle of a set of rotation angles used to construct a quantum circuit can define a respective quantum gate of a set of quantum gates of the quantum circuit. For example, a first quantum measurement can be generated by a first quantum circuit constructed based on a first set of parameters (\vec{θ₁}) and a second quantum measurement can be generated by a second quantum circuit constructed based on a second set of parameters (\vec{θ₂}). In at least one embodiment, each quantum measurement is stored in a respective string.

Illustratively, a first quantum state |ψ [symbol] and a second quantum state |φ [symbol] can refer two quantum states that were prepared by a first quantum circuit H₁(θ) based on a first set of parameter values, and a second quantum circuit H₂(θ) based on a second set of parameter values, that approximately create the same states (| [symbol] ψ|φ [symbol] |²→1). Thus, performing the same measurements on a large ensemble can yield the approximately same expectation values. For example, the first quantum state |ψ [symbol] can be equal to

$${{U}_{0}^{0} ( {θ}_{0} ) \cdot {U}_{1}^{0} ( {θ}_{1} ) \cdot … \cdot {U}_{{k}_{0}}^{0} ( {θ}_{{k}_{0}} ) ⊗ {U}_{0}^{1} ( {θ}_{0} ) … {U}_{{k}_{1}}^{1} ( {θ}_{{k}_{1}} ) ⊗ … ⊗ {U}_{0}^{l} ( {θ}_{0} ) … {U}_{{k}_{l}}^{l} ( {θ}_{{k}_{l}} ) \vert 0 〉}^{⊗ n} ,$$

where

$${U}_{j}^{i} ( {θ}_{{k}_{i}} )$$

is the j-th ansatz acting on the i-th qubit, and kᵢ is the last index of the i-th qubit, and l is the index of the last qubit. It is noted that kₗ is not necessarily equal to 1 or any of the other kᵢ. The second state |φ [symbol] can be equal to H₂(θ)|0 [symbol] ^{⊗n}). After obtaining the quantum measurements (locally or globally) by GP-implementing the quantum circuits, the quantum measurements can be stored in respective classical registers \vec{s}₁, \vec{s}₂.

The QCP facilitation component can then cause a ground state of the qubit corresponding to the observable to be estimated (or determined) based on the quantum measurements (e.g., at least the first quantum measurement and the second quantum measurement), and a relationship between the sets of parameter values (e.g., at least the first set of parameter values and the second set of parameter values). In at least one embodiment, causing the ground state to be estimated includes the QCP facilitation component sending the multiple quantum measurements to multiple respective classical computers (e.g., HPCs) for parallel processing to determine multiple respective sets of updated parameter values. For example, the first quantum measurement and the second quantum measurement can be received by the QCP facilitation component and sent to a first classical computer and a second classical computer, respectively, to perform the optimization method. In at least one embodiment, causing the ground state to be estimated further includes the QCP facilitation component receiving the multiple sets of updated parameter values from the respective classical computers (e.g., receiving at least the first set of updated parameter values from the first classical computer and the second set of updated parameter values from the second classical computer), and estimating the ground state based on the multiple sets of updated parameter values, the initial sets of parameter values used to generate the first and second measurements, and a known relationship between the initial sets of parameter values.

The QCP facilitation component can send each string to a respective classical computer that performs the optimization method based on its respective string. The QCP facilitation component can then receive the results generated by the classical computers (e.g., the updated sets of parameters), and compare the results. Trivially, if the circuits are applying the same Hamiltonian, then the expectation values can be approximately equal after enough samples.

In at least one embodiment, each qubit is measured locally one by one by multiple quantum circuits in parallel until the expectation value of the local qubit is correct with a sufficiently high degree of confidence (e.g., the confidence value satisfies a threshold condition). For example, multiple quantum circuits may generate respective measurements of a qubit, and multiple quantum measurements may be performed by multiple respective classical computers (e.g., HPCs) to determine multiple sets of updated parameter values. The information for each iteration step for each qubit can be maintained in a classical register, and the results for each iteration step can be averaged until a sufficient approximation with a high degree of confidence is obtained. The collective communication protocol can continue to run until a threshold condition is met. When the threshold condition is met, the collective communication protocol can be used to measure the next qubit. The information that was transmitted via the interconnect link, but not utilized by the classical computer during the optimization method, can be stored in classical memory (e.g., a classical register) even if the protocol for the current qubit ends.

Illustratively, the threshold condition can be defined by Pr[| [symbol] −(S)| [symbol] Sₙ [symbol] |≥t]≤ϵ, where ϵ is an approximation condition, Sₙ is the sum of the quantum measurements, [symbol] is the quantum measurement from the original quantum circuit, Pr[| [symbol] − [symbol] Sₙ [symbol] |≥t] refers to the probability that a metric | [symbol] − [symbol] Sₙ [symbol] | being less than or equal to some real number t. | [symbol] − [symbol] Sₙ [symbol] | can come in form of several probability metrics such as the fidelity F(\tilde{ρ},ρ)=√√ρ\tilde{ρ}√ρ, Hilbert Smidt distance: |ρ−\tilde{ρ}|²_{HS} etc., where ρ, \tilde{ρ} are the expected the density matrix for a (local) qubit and the approximated density matrix for the qubit, respectively.

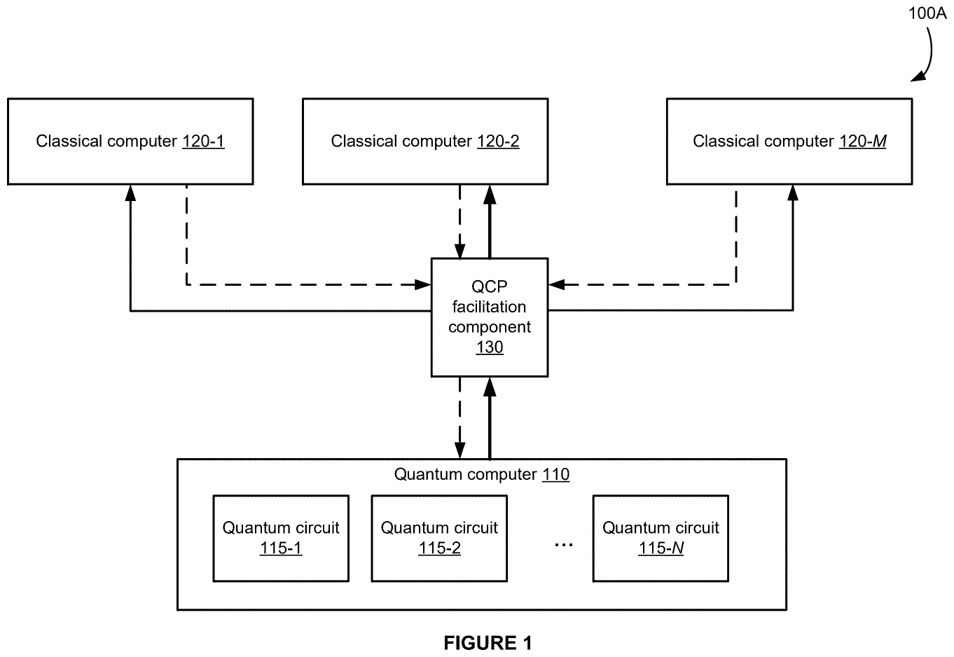

For a state that undergoes an effective quantum channel that induces noise on it, one can bound the error by |ρ−\tilde{ρ}|≤ϵ, where ρ is the expected density matrix of the system and \tilde{ρ} is the approximate state and includes the noises in the channel. For a noise parameter γₜₒₜ that is the sum of internal and external noises: γₜₒₜ=γᵢₙₜₑᵣ+γₑₓₜₑᵣ, the sample complexity can be estimated to scale as

$$O ( \frac{kd}{{ϵ}^{2}} ) ,$$

where d is the dimension of the quantum state and k is the rank of the matrix. The k depends on γₜₒₜ, because noise increases the rank of the matrix which increases the number of samples. Further details regarding implementing quantum communication channels will now be described below with reference to FIGS. 1-13C.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., raytracing, path tracing, etc.), collaborative content creation for 3D assets, generative AI operations using (e.g., large) language models, cloud computing and/or any other suitable applications. The systems and methods described herein may be used in a system for compiling a quantum circuit, a system for executing a quantum circuit, a system for measuring a quantum state, and/or a system for measuring a state of a qubit or qubits.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using (large) language models, systems for performing light transport simulation, systems for performing collaborative content creation for 3D assets, systems implemented at least partially using cloud computing resources, and/or other types of systems.

In the following and preceding description, numerous specific details are set forth to provide a more thorough understanding of at least one embodiment. However, it will be apparent to one skilled in the art that the inventive concepts may be practiced without one or more of these specific details. Following figures set forth, without limitation, example systems and methods that implement collective communication protocols for quantum metrology.

FIG. 1 is a diagram of an example hybrid quantum-classical system (“system”) 100, according to at least one embodiment. In at least one embodiment, the system 100 includes a quantum metrology network or quantum network. In at least one embodiment, a quantum metrology network is included within a datacenter. The datacenter may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the datacenter. In at least one embodiment, trained or deployed machine learning models corresponding to one or more neural networks may be used to infer or predict information using resources described above with respect to the datacenter by using weight parameters calculated through one or more training techniques, such as but not limited to those described herein. In at least one embodiment, a quantum metrology network is not used in a datacenter.

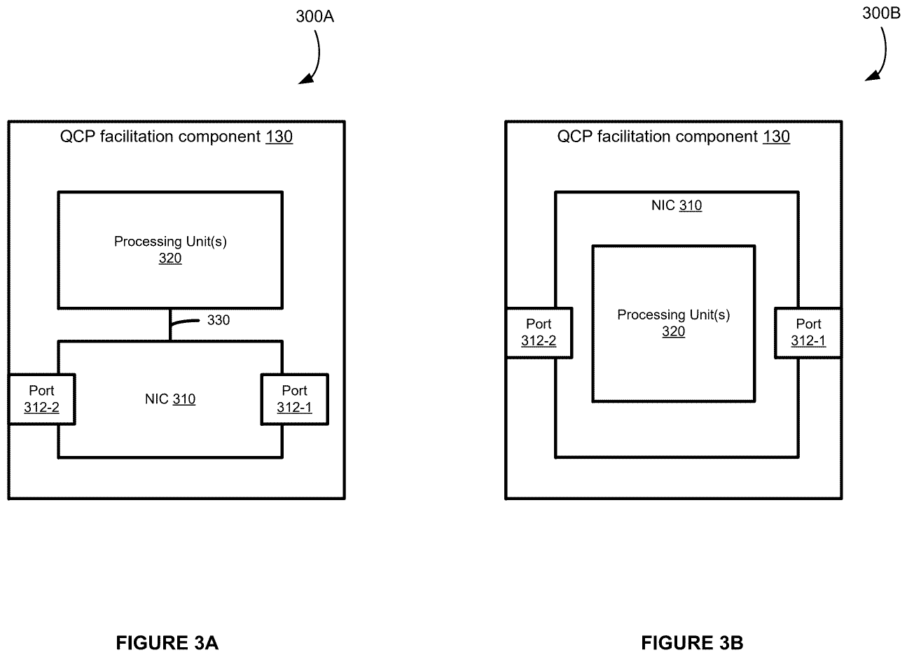

In this illustrative example, system 100 includes at least one quantum computer 110, which may implement quantum circuits 115-1 through 115-N, multiple classical computers 120-1 through 120-M, and at least one quantum communication protocol (QCP) facilitation component 130. In at least one embodiment, each of classical computers 120-1 through 120-M is a high-performance computer (HPC). For example, an HPC can be a supercomputer. More specifically, an HPC can be equipped with multiple processors and/or cores that work together to enable parallel processing of large amounts of data. An HPC can include central processing units (CPUs) and/or graphics processing units (GPUs). An HPC can have large memory and/or storage resources to facilitate the processing and storage of the data. In at least one embodiment, the at least one QCP facilitation component 130 includes at least one NIC. Further details regarding QCP facilitation components including NICs will be described below with reference to FIGS. 3A-3B.

In at least one embodiment, quantum computer 110 implements multiple quantum circuits 115-1 through 115-N. Each of the quantum circuits 115-1 through 115-N can be constructed based on a respective set of parameters (e.g., a unique set of parameters). In at least one embodiment, a set of parameters includes a set of rotation angles. For example, each rotation angle of a set of rotation angles corresponding to a quantum circuit can be used to define a respective quantum gate of a set of quantum gates of the quantum circuit. In at least one embodiment, each of quantum circuits 115-1 through 115-N is implemented on at least one quantum computer 110 in parallel.

In at least one embodiment, the number of classical computers 120-1 through 120-M is equal to the number of quantum circuits 115-1 through 115-N (e.g., M is equal to N). In at least one embodiment, the number of classical computers 120-1 through 120-M is different from the number of quantum circuits 115-1 through 115-N (e.g., M is different from N).

The system 100 can support a quantum communication protocol that implements a hybrid quantum-classical method to identify a set of parameter values that corresponds to the ground state of a qubit with respect to an observable of the qubit. In at least one embodiment, the observable is energy, and the ground state of a qubit is the ground state energy of the qubit (e.g., the lowest energy state of the qubit). More specifically, the energy of the qubit can be the Hamiltonian representing the total energy of the qubit (e.g., the sum of the kinetic energy and the potential energy of the qubit), and the ground state energy can be the ground state of energy of the Hamiltonian of the wavefunction representing the qubit.

For example, each of the quantum circuits 110-1 through 110-N can generate a respective quantum measurement, and each of the respective quantum measurements may be sent to QCP facilitation component 130. In at least one embodiment, each of quantum circuits 115-1 through 115-N can be an initial quantum circuit (e.g., ansatz circuit) constructed based on a set of initial parameter values. An initial quantum circuit can be selected or designed with any suitable set of initial parameters. An initial quantum circuit can be constructed by a user based on domain knowledge.

Quantum measurements respectively generated by respective ones of the quantum circuits 110-1 through 110-N can be received and stored by QCP facilitation component 130 in classical memory (e.g., respective classical registers). In at least one embodiment, the one or more quantum measurements are stored as one or more respective strings (e.g., \vec{s}₁, \vec{s}₂, . . . \vec{s}_{N}).

After storing the quantum measurements, QCP facilitation component 130 can send the quantum measurements to respective ones of classical computers 120-1 through 120-M. Each quantum measurement can be used to determine a respective energy of the quantum system as an objective function or loss function of a set of parameters, referred to as E(θ). Each of classical computers 120-1 through 120-M can perform an optimization method to determine a respective set of updated parameter values based on the respective quantum measurement (e.g., a set of updated parameter values that corresponds to a minimum energy of the quantum system). In at least one embodiment, the optimization methods are performed in parallel. More specifically, each of the classical computers 120-1 through 120-M can identify a respective set of updated parameter values that, when used to construct a quantum circuit, can minimize E(θ) (e.g., a global or absolute minimum). Any suitable optimization method can be used to identify the set of updated parameter values. Examples of optimization methods include gradient descent, constrained optimization methods, Bayesian optimization methods, Nelder-Mead, etc.

The sets of updated parameters can be sent to QCP facilitation component 130 for further processing. For example, QCP facilitation component can perform a comparison between the sets of updated parameters. A relationship can exist between the sets of parameter values. The QCP facilitation component 130 may compare the respective sets of updated parameter values, optionally in view of one or more prior sets of parameter values for which measurements were generated, and use such information in addition to known relationships between the prior sets of parameter values and/or the updated sets of parameter values (e.g., known angular relationships), to generate further updated sets of parameter values. In at least one embodiment, if the updated sets of parameter values are sufficiently similar (e.g., similar within a threshold difference), a determination may be made that a solution has been found.

Iterative loops of a quantum computer implementing a quantum circuit constructed based on a set of parameter values to generate a quantum measurement, and a classical computer performing an optimization method to identify a set of parameter values based on the quantum measurement, can continue until convergence is reached (e.g., the optimization method converges to the ground state energy of the quantum system), or until the accuracy of the result satisfies a threshold condition (e.g., a target level of accuracy is achieved). More specifically, the lowest value found during the optimization method can correspond to the ground state (e.g., ground state energy) of the quantum system. The set of parameter values determined to result in the lowest value can be a final set of parameter values that can be used to construct the quantum circuit.

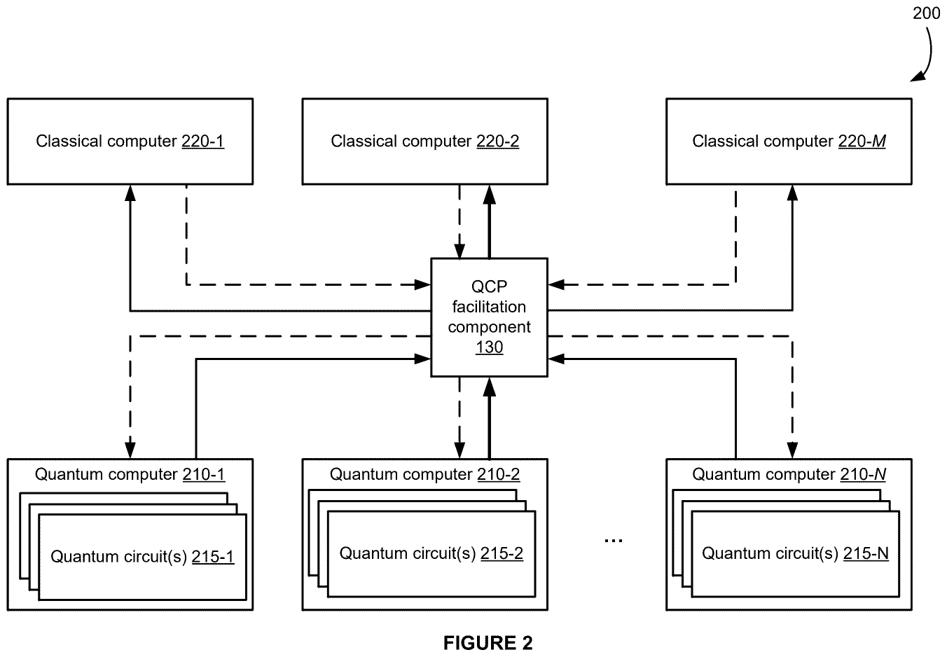

FIG. 2 is a diagram of an example hybrid quantum-classical system (“system”) 200, according to at least one embodiment. In at least one embodiment, system 200 includes a quantum metrology network or quantum network. In at least one embodiment, a quantum metrology network is included within a datacenter. In at least one embodiment, a quantum metrology network is not used in a datacenter.

In this illustrative example, system 200 includes multiple quantum computers 210-1 through 210-N, multiple classical computers 220-1 through 220-M, and at least one QCP facilitation component 230. Each of quantum computers 210-1 through 210-N can implement at least one quantum circuit 215-1 through 215-N, respectively. Each of quantum computers 210-1 through 210-N can be similar to at least one quantum computer 110 of FIG. 1, quantum circuits 215-1 through 215-N can be similar to quantum circuits 115-1 through 115-N of FIG. 1, classical computers 220-1 through 220-M can be similar to classical computers 120-1 through 120-M, and QCP facilitation component 230 can be similar to QCP facilitation component 130 of FIG. 1. System 200 can support a similar quantum communication protocol that implements the hybrid quantum-classical method as described above with reference to FIG. 1. For example, the ground state associated with the qubits of the multiple quantum computers may be determined and compared during testing after manufacturing of the quantum computers in order to determine convergence to the same solution, and thus meeting a quality control criterion (e.g., the qubits are all constructed within some specification). If the quantum computers do not meet the quality control criterion (e.g., the results differ by more than a threshold), then one or more of the quantum computers do not meet the quality control criterion.

Further details regarding methods of implementing a collective communication protocol using the system 100 and/or the system 200 will now be described below with reference to FIGS. 3A-7.

FIG. 3A illustrates components of an example hybrid quantum-classical system (“system”) 300A, in accordance with at least one embodiment. In at least one embodiment, the system 300A corresponds to system 100 of FIG. 1 and/or system 200 of FIG. 2. In at least one embodiment, the system 300 includes QCP facilitation component 130 of FIGS. 1-2.

In at least one embodiment, QCP facilitation component 130 includes NIC 310. In at least one embodiment, NIC 310 includes port 312-1 and port 312-2. In at least one embodiment, QCP facilitation component 130 includes one or more processing units 320 communicably coupled to NIC 310 via link 330. In at least one embodiment, link 230 is a PCIe link.

In at least one embodiment, processing unit(s) 320 include one or more central processing units (CPUs). In at least one embodiment, processing unit(s) 320 include one or more graphics processing units (GPUs). In at least one embodiment, processing unit(s) 320 include one or more data processing units (DPUs). In at least one embodiment, a DPU is a software programmable multi-core CPU. In at least one embodiment, a DPU includes a high-performance network interface. In at least one embodiment, a DPU includes a programmable acceleration engine.

In at least one embodiment, one or more of port 312-1 or port 312-2 is an Ethernet port for receiving Ethernet messages. In at least one embodiment, one or more of port 312-1 or port 312-2 is an InfiniBand (IB) port for receiving or transmitting IB messages. In at least one embodiment, a network communication protocol one or more of port 312-1 or port 312-2 is an Internet Protocol (IP) port for receiving or transmitting IP messages. In at least one embodiment, one or more of port 312-1 or port 312-2 is a Fibre Channel port for receiving or transmitting Fibre Channel messages. In at least one embodiment, one or more of port 312-1 or port 312-2 is an Omni-Path port for receiving or transmitting Omni-Path messages. In at least one embodiment, processing unit(s) 320 encapsulate data in network communication protocol data to generate a message in accordance with a network communication protocol. In at least one embodiment, a message includes a packet generated in accordance with a network communication protocol. In at least one embodiment, a set of preprocessed data is included in a payload of a message. In a least one embodiment, a network communication protocol is Ethernet. In at least one embodiment, a network communication protocol is IB. In at least one embodiment, a network communication protocol is IP. In at least one embodiment, a network communication protocol is Fibre Channel. In at least one embodiment, a network communication protocol is Omni-Path.

In at least one embodiment, NIC 310 receives, from at least one quantum computer, at least one quantum measurement generated by at least one quantum circuit, as described above with reference to FIGS. 1-2. In at least one embodiment, NIC 310 sends at least one quantum measurement generated by at least one quantum circuit to processing unit(s) 320 for processing via link 230. In at least one embodiment, NIC 310 sends, to at least one classical computer, at least one quantum measurement received from at least one quantum computer for processing, as described above with reference to FIGS. 1-2. In at least one embodiment, NIC 310 receives, from at least one classical computer, at least one set of updated parameter values, as described above with reference to FIGS. 1-2. In at least one embodiment, NIC 310 sends at least one set of updated parameter values received from at least one classical computer to processing unit(s) 320 for processing via link 230.

In at least one embodiment, NIC 310 receives a time synchronization message from a clock source. In at least one embodiment, NIC 310 sends a time synchronization message to processing unit(s) 320 for processing via link 230. In at least one embodiment, processing unit(s) 320 implement a time synchronization protocol to synchronize a clock of QCP facilitation component 130 with a clock source. In at least one embodiment, a time synchronization protocol is Precision Time Protocol (PTP). In at least one embodiment, QCP facilitation component 130 supports hardware timestamping and/or software timestamping. In at least one embodiment, port 312-1 and port 312-2 are synchronized to improve time accuracy that may have been lost due to a time delay. In at least one embodiment, port 312-1 is synchronized to a same clock as port 312-2. In at least one embodiment, QCP facilitation component 130, upon receiving a time synchronization message, adds a timestamp to time synchronization packet. In at least one embodiment, timestamp indicates a time at which a time synchronization message arrived at port 312-1 or port 312-2. In at least one embodiment, a purpose of adding a timestamp to a time synchronization packet is to eliminate a need to account for time it takes to send data to processing unit(s) 320 for processing. In at least one embodiment, by knowing a time that a time synchronization message arrived at port 312-1 or port 312-2, an amount of time it takes for data to arrive at processing unit(s) 320 for processing is made virtually irrelevant.

FIG. 3B illustrates components of an example hybrid quantum-classical system (“system”) 300B, in accordance with at least one embodiment, the system 300A corresponds to system 100 of FIG. 1 and/or system 200 of FIG. 2. In at least one embodiment, the system 300 includes QCP facilitation component 130 of FIGS. 1-2. In at least one embodiment, similar to quantum metrology network 300A of FIG. 3A, QCP facilitation component 130 includes NIC 310, port 312-1 and port 312-2. In at least one embodiment, as shown in FIG. 3B, processing unit(s) 320 are included within NIC 310 (e.g., there is link 330 between NIC 310 and processing unit(s) 320. Further details regarding components 130, 310, 312-1, 312-2, and 320 are described above with reference to FIGS. 1-3A.

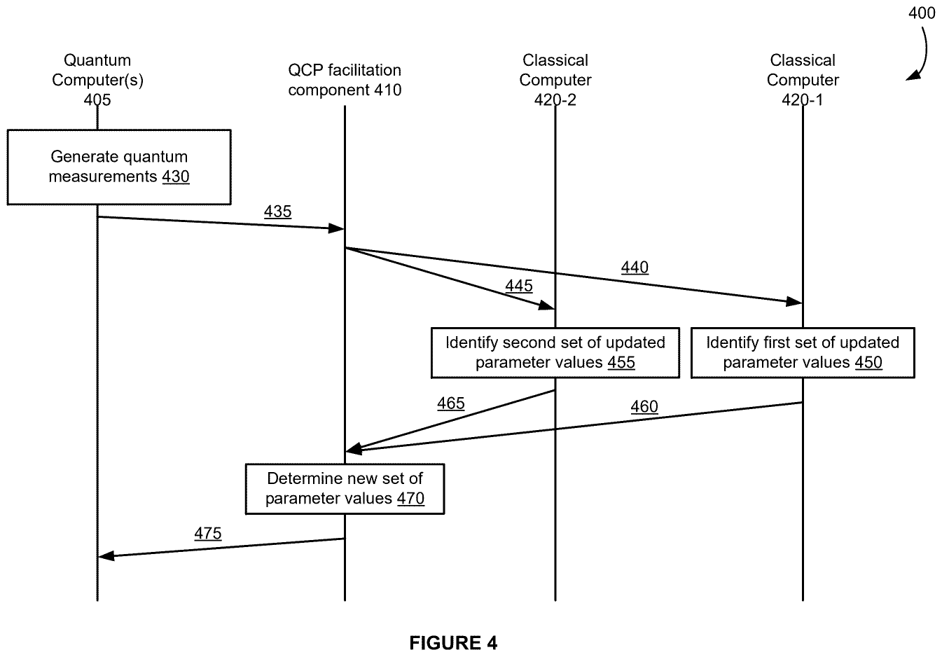

FIG. 4 is a timing diagram 400 illustrating an example method of implementing a quantum communication protocol, in accordance with at least one embodiment. As shown, diagram 400 shows line 405 corresponding to one or more quantum computers (“quantum computer(s)”), line 410 corresponding to a QCP facilitation component, line 420-1 corresponding to a first classical computer (e.g., first HPC), and line 420-1 corresponding to a second classical computer (e.g., second HPC). Although two classical computers are represented, the number of classical computers should not be considered limiting.

As shown, at 430, the quantum computer(s) generate at least a first quantum measurement and a second quantum measurement. More specifically, the first quantum measurement can be generated by implementing a first quantum circuit constructed based on a first set of parameters, and the second quantum measurement can be generated by implementing a second quantum circuit constructed based on a second set of parameters.

At 435, the quantum computer(s) send at least the first and second quantum measurements to the QCP facilitation component.

At 440, the QCP facilitation component sends at least the first quantum measurement to the first classical computer and, at 450, the first classical computer identifies (e.g., generates) a first set of updated parameter values using an optimization method based on the first quantum measurement.

At 445, the QCP facilitation component sends at least the second quantum measurement to the second classical computer and, at 455, the second classical computer identifies a second set of updated parameter values using an optimization method based on the second quantum measurement.

At 460, the first classical computer sends the first set of updated parameter values to the QCP facilitation component and, at 470, the second classical computer sends the second set of updated parameter values to the QCP facilitation component.

At 470, the QCP facilitation component determines a new set of parameter values based on the first and second set of updated parameter values.

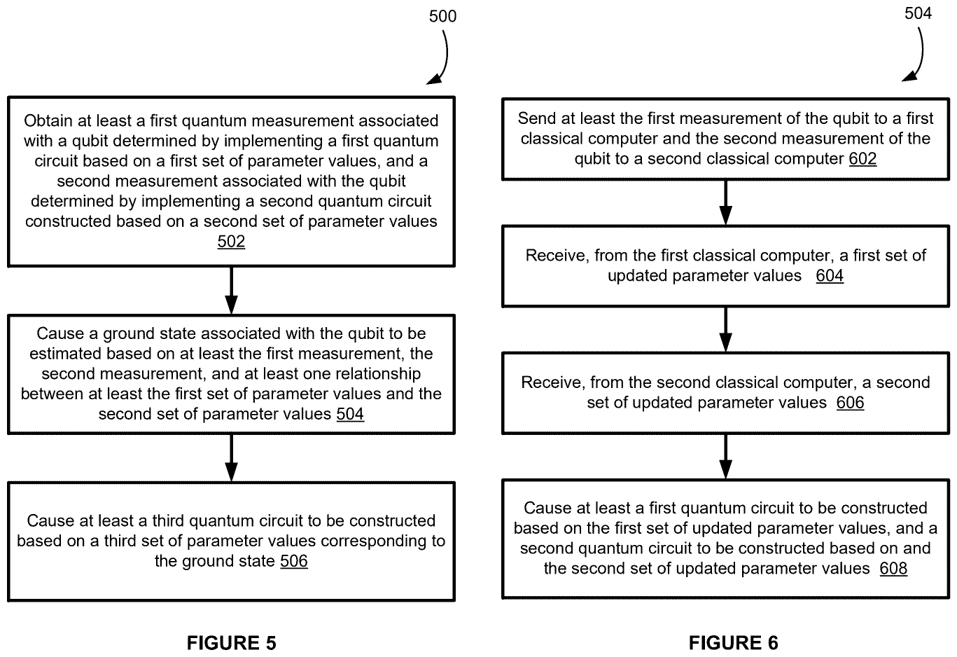

At 475, the QCP facilitation component sends the new set of parameter values to the quantum computer(s). The new set of parameter values can replace the previous set of parameter values used to construct the quantum circuits that previously generated the quantum measurements at 430. Further details regarding the operations performed at 430-475 are described above with reference to FIGS. 1-2 and will now be described below with reference to FIGS. 5-7.

FIG. 5 illustrates a flow diagram of an example method 500 of implementing quantum communication channels, in accordance with at least one embodiment. In at least one embodiment, method 500 is be performed by a processing logic that may comprise hardware (e.g., circuitry, dedicated logic, programmable logic, microcode, etc.), software (e.g., instructions run on a processing device to perform hardware simulation), firmware, or a combination thereof. In at least one embodiment, at least some operations of method 500 are performed by a computing device in communication with and/or included in a datacenter. In at least one embodiment, at least some operations of method 500 are performed by at least one processing device of a quantum metrology network. In at least one embodiment, at least one processing device includes a NIC. In at least one embodiment, a NIC includes one or more DPUs. In at least one embodiment, a NIC includes one or more CPUs. In at least one embodiment, a NIC includes one or more GPUs.

At block 502, processing logic obtains at least a first quantum measurement associated with a qubit determined by implementing a first quantum circuit constructed based on a first set of parameter values, and a second quantum measurement of the observable associated with the qubit determined by implementing a second quantum circuit constructed based on a second set of parameter values. In at least one embodiment, at least the first and second quantum circuits are implemented by a single quantum computer. In at least one embodiment, at least the first and second quantum circuits are implemented by respective quantum computers.

Each parameter of a set of parameters is a tunable parameter that can be varied to change the operation of a quantum circuit. For example, each set of parameters can include one or more parameters can be used to parameterize a set of quantum gates of a quantum circuit. In at least one embodiment, the first set of parameter values includes a first set of rotation angles, and the second set of parameter values includes a second set of rotation angles. For example, adjusting a rotation angle can include adjusting a rotation gate of a quantum circuit, which can modify the position of a qubit and thus alter the quantum measurement made by the quantum circuit.

The first quantum measurement and the second quantum measurement can correspond to an observable associated with the qubit. In at least one embodiment, the observable is energy (e.g., the Hamiltonian). For example, the first quantum measurement can correspond to a first set of expectation values of a first Hamiltonian determined based on the first set of parameter values, and the second quantum measurement can correspond to a second set of expectation values of a second Hamiltonian determined based on the second set of parameter values.

At block 504, processing logic causes a ground state associated with the qubit to be estimated based on at least the first quantum measurement of the qubit, the second quantum measurement of the qubit, and at least one relationship between at least the first set of parameter values and the second set of parameter values. More specifically, a hybrid quantum-classical method can be used to estimate the ground state. In at least one embodiment, processing logic determines whether a wave function associated with the state of the qubit satisfies a threshold condition, and in response to determining that the wave function satisfies the threshold condition, completes a measurement of the qubit. For example, the determination can be made based on a probability metric, as a difference between probability distributions (e.g., fidelity). In embodiments, multiple different HPCs each estimates a ground state of the qubit associated with a respective measurement. The one or more HPCs and/or a NIC may then determine an updated ground state estimate based on multiple measurements and at least one relationship between at last the first set of parameter values and the second set of parameter values. An example of a method of causing the ground state to be estimated at block 504 will be described below with reference to FIG. 6.

At block 506, processing logic causes at least a third quantum circuit (and/or a fourth quantum circuit) to be constructed based on a third set of parameter values (and/or a fourth set of parameter values) corresponding to the ground state. More specifically, the third and/or fourth sets of parameter values are the set(s) of parameter values resulting from convergence of results of the hybrid quantum-classical method. Further details regarding blocks 502-506 are described above with reference to FIGS. 1A-4 and will now be described below with reference to FIG. 6.

FIG. 6 illustrates a flow diagram of an example method 504 of causing a ground state of a qubit to be estimated, in accordance with at least one embodiment. In at least one embodiment, method 504 is be performed by a processing logic that may comprise hardware (e.g., circuitry, dedicated logic, programmable logic, microcode, etc.), software (e.g., instructions run on a processing device to perform hardware simulation), firmware, or a combination thereof. In at least one embodiment, at least some operations of method 504 are performed by a computing device in communication with and/or included in a datacenter. In at least one embodiment, at least some operations of method 504 are performed by at least one processing device of a quantum metrology network. In at least one embodiment, at least one processing device includes a NIC. In at least one embodiment, a NIC includes one or more DPUs. In at least one embodiment, a NIC includes one or more CPUs. In at least one embodiment, a NIC includes one or more GPUs.

It is assumed that processing logic has obtained at least the first quantum measurement and the second quantum measurement (e.g., step 502 of FIG. 5). At block 602, processing logic sends at least the first quantum measurement to a first classical computer and the second quantum measurement of the qubit to a second classical computer. In at least one embodiment, at least one of the first classical computer or the second classical computer includes an HPC.

At block 604, processing logic receives, from the first classical computer, a first set of updated parameter values. At block 606, processing logic receives, from the second classical computer, a second set of updated parameter values. More specifically, each set of updated parameter values is identified as a set of parameters that corresponds to a minimum value of an observable (e.g., global minimum value) determined by a classical computer implementing an optimization method. For example, the minimum value of an observable can be a minimum energy value (e.g., Hamiltonian).

At block 608, processing logic causes at least a first quantum circuit to be constructed based on the first set of updated parameter values, and a second quantum circuit to be constructed based on the second set of updated parameter values. Further details regarding blocks 602-608 are described above with reference to FIGS. 1A-5.

As described above, datacenters, high performance computing clusters, and/or the like are often formed of various computing components or networked devices, and communication networks formed of electrical and/or optical devices may be used to enable communication between the networked devices forming these implementations.

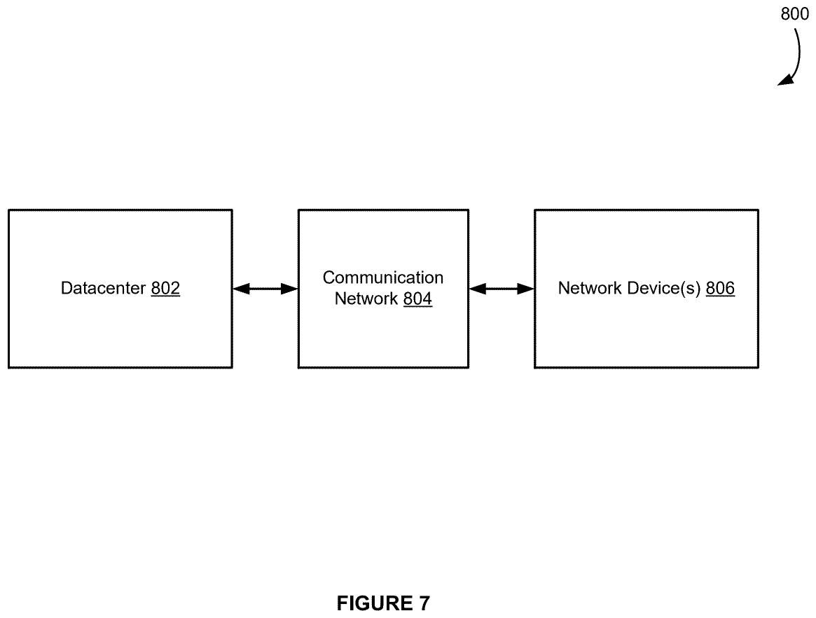

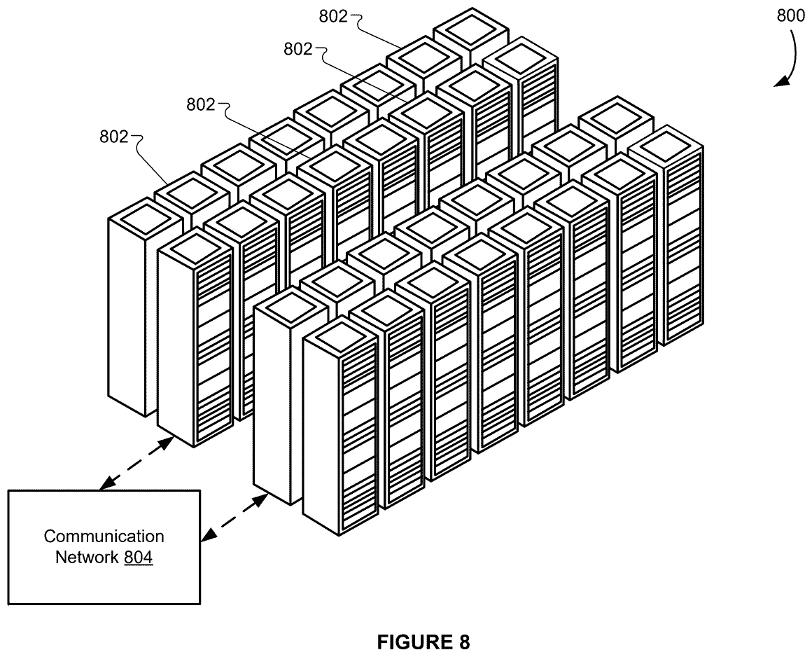

FIGS. 7-8 are diagrams illustrating an example network architecture 800 that can be used to implement quantum communication protocols, in accordance with at least one embodiment. For example, the network architecture 800 may include a datacenter 802, a communication network 804, and network device(s) 806. The network architecture 800 may illustrate a general computing architecture within which more specific systems and/or subsystems may function.

For example, the datacenter 802 may be a centralized facility designed to house computing resources and related components. The datacenter 802 may operate to support the infrastructure required for advanced computational tasks, for efficient, secure, and reliable operations. The datacenter 802 may include the building and structural components, including power supplies, cooling systems, fire suppression systems, and physical security measures that are configured to maintain optimal operating conditions and/or protect the equipment from environmental hazards and unauthorized access. An example datacenter 802 may include high-performance servers or compute nodes, often arranged in racks as shown in network architecture 800, and connected through high-speed networks as described herein. These servers may include processors (e.g., central processing units (CPUs), graphics processing units (GPUs), data processing units (DPUs) and/or the like), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications.

The datacenter 802 may include high-speed network equipment, such as network switches, routers, firewalls, and/or the like to facilitate fast and secure data transmission within the datacenter 802 (e.g., between the servers or compute nodes) and between external networks. The datacenter 802 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, the datacenter 802 may support high-performance computing tasks. Examples of various network topologies may include hierarchical networking topologies such as the fat tree topology, Slim Fly topology, Dragonfly topology, and/or the like.

The communication network 804 may communicably couple the datacenter 802 with network device(s) 806 and other external devices for data exchange and connectivity. Examples of the communication network 804 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 804 to incorporate multiple network types and configurations may allow the datacenter 802 to adapt to diverse application needs, from general data communication to specialized HPC tasks. As described herein, the communication network 804 may leverage various optical components to establish communication links (e.g., communicably couple) between components in the architecture 800. As such, the communication network 804 may include various optical devices, transceivers, modules, and/or the like that are configured to generate optical signals (e.g., provide optical transmitter functionality) and/or receive optical signals (e.g., provide optical receiver functionality).

The network device(s) 806 may include a variety of computing devices capable of transmitting and receiving signals over the communication network 804. The network device(s) 806 may range from personal computing devices to complex server configurations. Examples include Personal Computers (PCs), laptops, tablets, smartphones, and servers. The network device(s) 806 may facilitate user interactions with the datacenter 802, allowing for data input, retrieval, and processing from remote locations. In addition to individual computing devices, the network device(s) 806 may also include collections of servers or additional datacenters. For instance, these could be other datacenters similar to or the same as datacenter 802. Such an interconnection may allow for the formation of a distributed computing environment for improved redundancy, load balancing, and disaster recovery capabilities. By linking multiple datacenters, the network architecture 800 may leverage geographically dispersed resources, optimizing performance and ensuring high availability.

As described herein, the datacenter 802 and/or the network device(s) 806 may include storage devices and processing circuitry for executing computing tasks, such as controlling the flow of data internally and over the communication network 804. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions. Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

Each network device 806 may include or be connected to a power distribution unit (PDU) that supplies power to power consuming elements of the network devices 806 (e.g., to the individual network switches within each network device). Related art PDUs may take the form of many power interfaces (e.g., AC and/or DC power outlets) integrated into a single power strip, which requires cumbersome power cable routing and complicated assembly/disassembly. In addition, these power strips cannot be easily replaced. For example, replacement or repair of one or a few of the outlets of the PDU or other elements of the PDU may require powering off the entire strip and disconnecting each power cable before installing a new power strip and reconnecting the power cables to each outlet. This process is time consuming and may result in unnecessary replacement of functioning parts of the PDU that are integrated with non-functioning parts of the PDU. In order to address these and other shortcomings of the related art, example embodiments provide PDUs capable of blind-mating or direct connection with power consuming elements within the network devices 806. In addition, PDUs according to example embodiments may be modular and function together to provide power to consumers so that replacement or repair of one non-functioning PDU module does not interrupt power to consumers of the network device connected to functioning PDU modules.

In addition, although not explicitly shown, the present disclosure contemplates that the datacenter 802 and network device(s) 806 may include one or more communication interfaces for facilitating wired and/or wireless communication between one another and other unillustrated elements of the network architecture 800. These communication interfaces may include a variety of technologies, including but not limited to Ethernet ports, fiber optic connections, Wi-Fi® transceivers, Bluetooth® modules, and cellular communication modules for integration and interoperability among the various components within the network architecture 800.

Furthermore, the present disclosure contemplates that the network architecture 800 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 800 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 800.

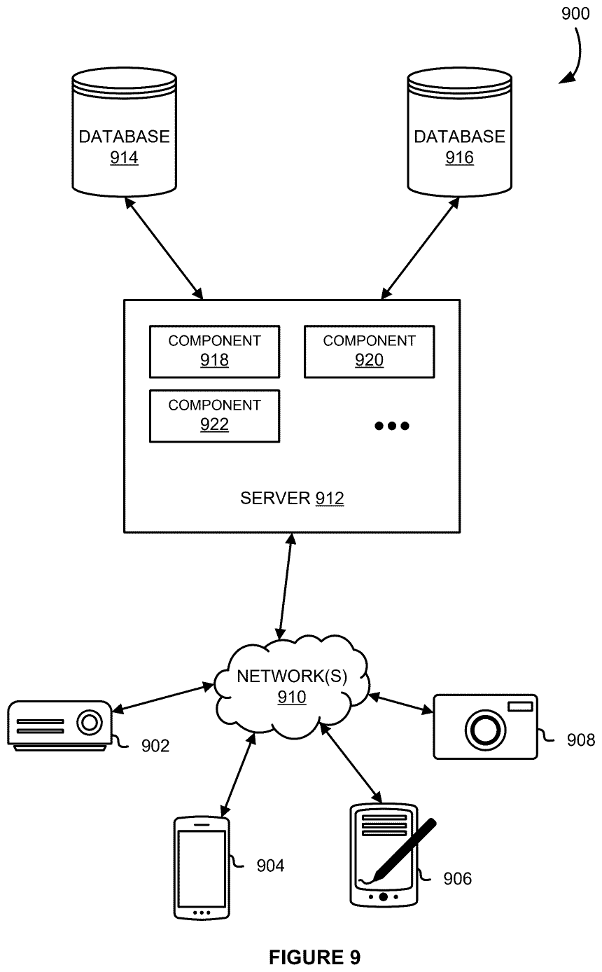

FIG. 9 illustrates a distributed system 900 that can be used to implement quantum communication protocols, in accordance with at least at least one embodiment. In at least one embodiment, distributed system 900 includes one or more client computing devices 902, 904, 906, and 908, which are configured to execute and operate a client application such as a web browser, proprietary client, and/or variations thereof over one or more network(s) 910. In at least one embodiment, server 912 may be communicatively coupled with remote client computing devices 902, 904, 906, and 908 via network 910. In at least one embodiment, server 912 includes a PCB having one or more power connectors as described herein above. In at least one embodiment, server 912 receives electrical power via a power delivery system as described herein above.

In at least one embodiment, server 912 may be adapted to run one or more services or software applications such as services and applications that may manage session activity of single sign-on (SSO) access across multiple datacenters. In at least one embodiment, server 912 may also provide other services or software applications can include non-virtual and virtual environments. In at least one embodiment, these services may be offered as web-based or cloud services or under a Software as a Service (SaaS) model to users of client computing devices 902, 904, 906, and/or 908. In at least one embodiment, users operating client computing devices 902, 904, 906, and/or 908 may in turn utilize one or more client applications to interact with server 912 to utilize services provided by these components.

In at least one embodiment, software components 918, 920 and 922 of system 900 are implemented on server 912. In at least one embodiment, one or more components of system 900 and/or services provided by these components may also be implemented by one or more of client computing devices 902, 904, 906, and/or 908. In at least one embodiment, users operating client computing devices may then utilize one or more client applications to use services provided by these components. In at least one embodiment, these components may be implemented in hardware, firmware, software, or combinations thereof. It should be appreciated that various different system configurations are possible, which may be different from distributed system 900. The embodiment shown in FIG. 9 is thus one example of a distributed system for implementing an embodiment system and is not intended to be limiting.

In at least one embodiment, client computing devices 902, 904, 906, and/or 908 may include various types of computing systems. In at least one embodiment, a client computing device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (e.g., a Microsoft Xbox gaming console with or without a Kinect® gesture input device), and/or a personal messaging device, capable of communicating over network(s) 910. Although distributed system 900 is shown with four client computing devices, any number of client computing devices may be supported. Other devices, such as devices with sensors, etc., may interact with server 912.

In at least one embodiment, network(s) 910 in distributed system 900 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, network(s) 910 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

In at least one embodiment, server 912 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, server 912 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by server 912 using software defined networking. In at least one embodiment, server 912 may be adapted to run one or more services or software applications.

In at least one embodiment, server 912 may run any operating system, as well as any commercially available server operating system. In at least one embodiment, server 912 may also run any of a variety of additional server applications and/or mid-tier applications, including HTTP (hypertext transport protocol) servers, FTP (file transfer protocol) servers, CGI (common gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, server 912 may include one or more applications to analyze and consolidate data feeds and/or event updates received from users of client computing devices 902, 904, 906, and 908. In at least one embodiment, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and/or variations thereof. In at least one embodiment, server 912 may also include one or more applications to display data feeds and/or real-time events via one or more display devices of client computing devices 902, 904, 906, and 908.

In at least one embodiment, distributed system 900 may also include one or more databases 914 and 916. In at least one embodiment, databases may provide a mechanism for storing information such as user interactions information, usage patterns information, adaptation rules information, and other information. In at least one embodiment, databases 914 and 916 may reside in a variety of locations. In at least one embodiment, one or more of databases 914 and 916 may reside on a non-transitory storage medium local to (and/or resident in) server 912. In at least one embodiment, databases 914 and 916 may be remote from server 912 and in communication with server 912 via a network-based or dedicated connection. In at least one embodiment, databases 914 and 916 may reside in a storage-area network (SAN). In at least one embodiment, any necessary files for performing functions attributed to server 912 may be stored locally on server 912 and/or remotely, as appropriate. In at least one embodiment, databases 914 and 916 may include relational databases, such as databases that are adapted to store, update, and retrieve data in response to SQL-formatted commands.

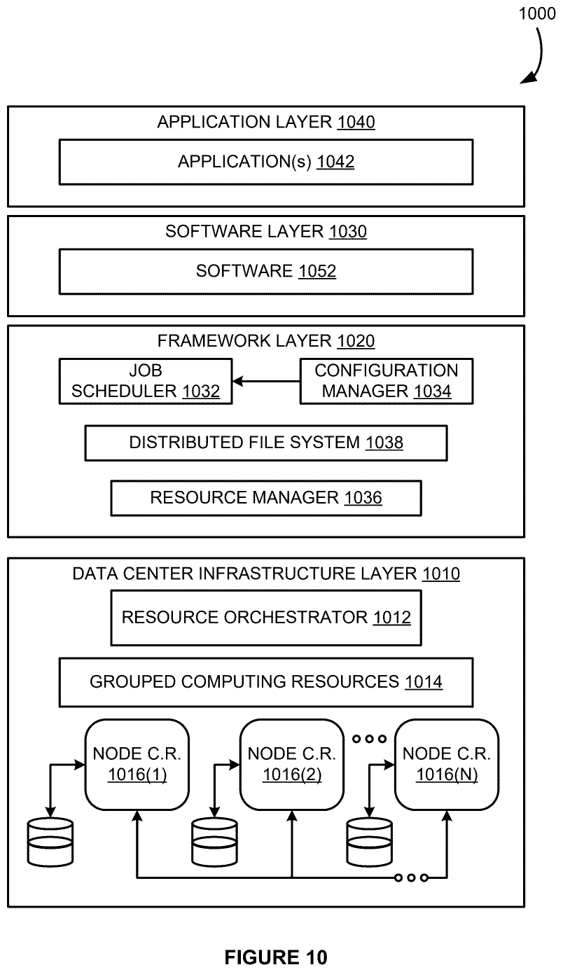

FIG. 10 illustrates an exemplary datacenter 1000, in accordance with at least at least one embodiment. In at least one embodiment, datacenter 1000 includes, without limitation, a datacenter infrastructure layer 1010, a framework layer 1020, a software layer 1030 and an application layer 1040.

In at least one embodiment, datacenter infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, grouped computing resources 1014 may include separate groupings of node C.R.s housed within one or more racks (not shown), or many racks housed in datacenters at various geographical locations (also not shown). Separate groupings of node C.R.s within grouped computing resources 1014 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1012 may configure or otherwise control one or more node C.R.s 1016(1)-1016(N) and/or grouped computing resources 1014. In at least one embodiment, resource orchestrator 1012 may include a software design infrastructure (“SDI”) management entity for datacenter 1000. In at least one embodiment, resource orchestrator 1012 may include hardware, software or some combination thereof.

In at least one embodiment, framework layer 1020 includes, without limitation, a job scheduler 1032, a configuration manager 1034, a resource manager 1036 and a distributed file system 1038. In at least one embodiment, framework layer 1020 may include a framework to support software 1052 of software layer 1030 and/or one or more application(s) 1042 of application layer 1040. In at least one embodiment, software 1052 or application(s) 1042 may respectively include web-based service software or applications, such as those provided by a cloud service provider. In at least one embodiment, framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1032 may include a Spark driver to facilitate scheduling of workloads supported by various layers of datacenter 1000. In at least one embodiment, configuration manager 1034 may be capable of configuring different layers such as software layer 1030 and framework layer 1020, including Spark and distributed file system 1038 for supporting large-scale data processing. In at least one embodiment, resource manager 1036 may be capable of managing clustered or grouped computing resources mapped to or allocated for support of distributed file system 1038 and job scheduler 1032. In at least one embodiment, clustered or grouped computing resources may include grouped computing resource 1014 at datacenter infrastructure layer 1010. In at least one embodiment, resource manager 1036 may coordinate with resource orchestrator 1012 to manage these mapped or allocated computing resources.

In at least one embodiment, software 1052 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. In at least one or more types of applications may include, without limitation, CUDA applications, 5G network applications, artificial intelligence application, datacenter applications, and/or variations thereof.

In at least one embodiment, any of configuration manager 1034, resource manager 1036, and resource orchestrator 1012 may implement any number and type of self-modifying actions based on any amount and type of data acquired in any technically feasible fashion. In at least one embodiment, self-modifying actions may relieve a datacenter operator of datacenter 1000 from making possibly bad configuration decisions and possibly avoiding underutilized and/or poor performing portions of a datacenter.

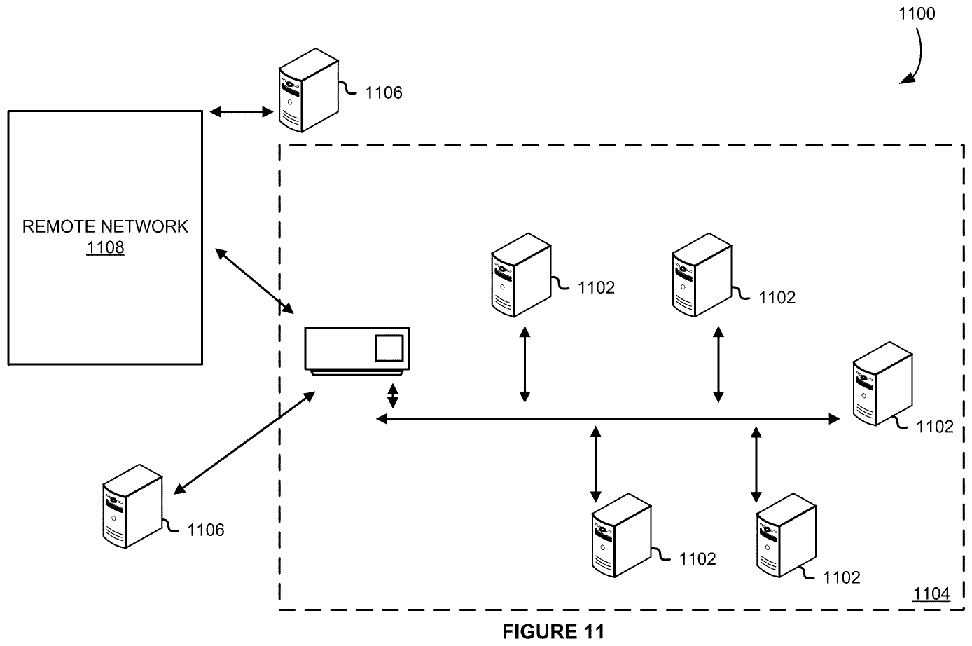

FIG. 11 illustrates a system 1100 including client-server network 1104 formed by a plurality of network server computers 1102 which are interlinked, in accordance with at least one embodiment. In at least one embodiment, each network server computer 1102 stores data accessible to other network server computers 1102 and to client computers 1106 and networks 1108 which link into a wide area network 1104. In at least one embodiment, configuration of a client-server network 1104 may change over time as client computers 1106 and one or more networks 1108 connect and disconnect from a network 1104, and as one or more trunk line server computers 1102 are added or removed from a network 1104. In at least one embodiment, when a client computer 1106 and a network 1108 are connected with network server computers 1102, client-server network includes such client computer 1106 and network 1108. In at least one embodiment, the term computer includes any device or machine capable of accepting data, applying prescribed processes to data, and supplying results of processes.

In at least one embodiment, client-server network 1104 stores information which is accessible to network server computers 1102, remote networks 1108 and client computers 1106. In at least one embodiment, network server computers 1102 are formed by main frame computers minicomputers, and/or microcomputers having one or more processors each. In at least one embodiment, server computers 1102 are linked together by wired and/or wireless transfer media, such as conductive wire, fiber optic cable, and/or microwave transmission media, satellite transmission media or other conductive, optic or electromagnetic wave transmission media. In at least one embodiment, client computers 1106 access a network server computer 1102 by a similar wired or a wireless transfer medium. In at least one embodiment, a client computer 1106 may link into a client-server network 1104 using a modem and a standard telephone communication network. In at least one embodiment, alternative carrier systems such as cable and satellite communication systems also may be used to link into client-server network 1104. In at least one embodiment, other private or time-shared carrier systems may be used. In at least one embodiment, network 1104 is a global information network, such as the Internet. In at least one embodiment, network is a private intranet using similar protocols as the Internet, but with added security measures and restricted access controls. In at least one embodiment, network 1104 is a private, or semi-private network using proprietary communication protocols.

In at least one embodiment, client computer 1106 is any end user computer, and may also be a mainframe computer, mini-computer or microcomputer having one or more microprocessors. In at least one embodiment, server computer 1102 may at times function as a client computer accessing another server computer 1102. In at least one embodiment, remote network 1108 may be a local area network, a network added into a wide area network through an independent service provider (ISP) for the Internet, or another group of computers interconnected by wired or wireless transfer media having a configuration which is either fixed or changing over time. In at least one embodiment, client computers 1106 may link into and access a network 1104 independently or through a remote network 1108.

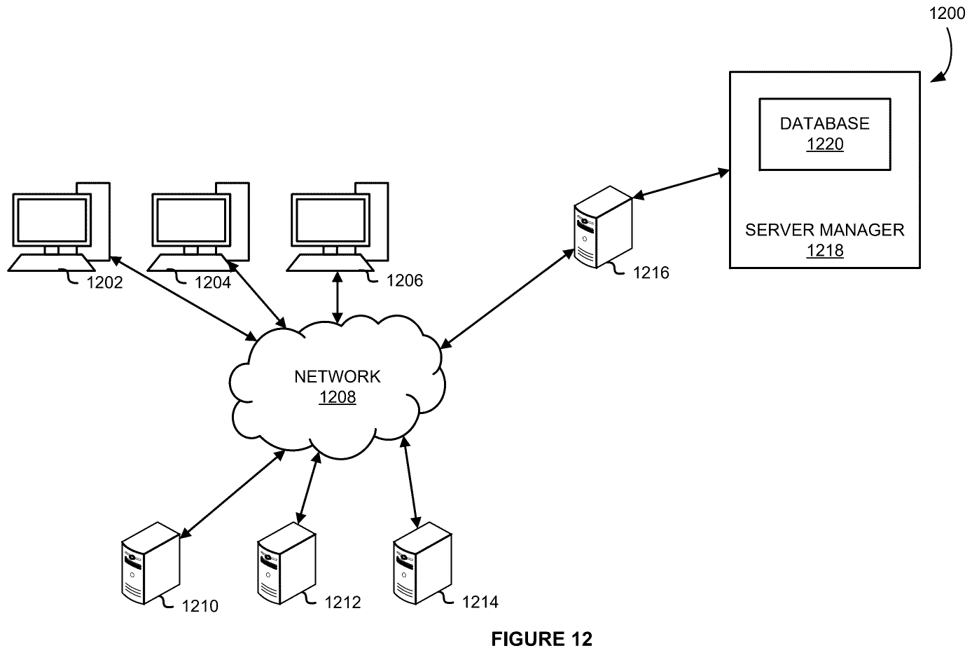

FIG. 12 illustrates a computer network 1200 connecting one or more computing machines, in accordance with at least at least one embodiment. In at least one embodiment, network 1208 may be any type of electronically connected group of computers including, for instance, the following networks: Internet, Intranet, Local Area Networks (LAN), Wide Area Networks (WAN) or an interconnected combination of these network types. In at least one embodiment, connectivity within a network 1208 may be a remote modem, Ethernet (IEEE 802.3), Token Ring (IEEE 802.5), Fiber Distributed Datalink Interface (FDDI), Asynchronous Transfer Mode (ATM), or any other communication protocol. In at least one embodiment, computing devices linked to a network may be desktop, server, portable, handheld, set-top box, personal digital assistant (PDA), a terminal, or any other desired type or configuration. In at least one embodiment, depending on their functionality, network connected devices may vary widely in processing power, internal memory, and other performance aspects. In at least one embodiment, communications within a network and to or from computing devices connected to a network may be either wired or wireless. In at least one embodiment, network 1208 may include, at least in part, the world-wide public Internet which generally connects a plurality of users in accordance with a client-server model in accordance with a transmission control protocol/internet protocol (TCP/IP) specification. In at least one embodiment, client-server network is a dominant model for communicating between two computers. In at least one embodiment, a client computer (“client”) issues one or more commands to a server computer (“server”). In at least one embodiment, server fulfills client commands by accessing available network resources and returning information to a client pursuant to client commands. In at least one embodiment, client computer systems and network resources resident on network servers are assigned a network address for identification during communications between elements of a network. In at least one embodiment, communications from other network connected systems to servers will include a network address of a relevant server/network resource as part of communication so that an appropriate destination of a data/request is identified as a recipient. In at least one embodiment, when a network 1208 comprises the global Internet, a network address is an IP address in a TCP/IP format which may, at least in part, route data to an e-mail account, a website, or other Internet tool resident on a server. In at least one embodiment, information and services which are resident on network servers may be available to a web browser of a client computer through a domain name (e.g. www.site.com) which maps to an IP address of a network server.

In at least one embodiment, a plurality of clients 1202, 1204, and 1206 are connected to network 1208 via respective communication links. In at least one embodiment, each of these clients may access network 1208 via any desired form of communication, such as via a dial-up modem connection, cable link, a digital subscriber line (DSL), wireless or satellite link, or any other form of communication. In at least one embodiment, each client may communicate using any machine that is compatible with network 1208, such as a personal computer (PC), workstation, dedicated terminal, personal data assistant (PDA), or other similar equipment. In at least one embodiment, clients 1202, 1204, and 1206 may or may not be located in a same geographical area.

In at least one embodiment, a plurality of servers 1210, 1212, and 1214 are connected to a network 1208 to serve clients that are in communication with a network 1208. In at least one embodiment, each server is typically a powerful computer or device that manages network resources and responds to client commands. In at least one embodiment, servers include computer readable data storage media such as hard disk drives and RAM memory that store program instructions and data. In at least one embodiment, servers 1210, 1212, 1214 run application programs that respond to client commands. In at least one embodiment, server 1210 may run a web server application for responding to client requests for HTML pages and may also run a mail server application for receiving and routing electronic mail. In at least one embodiment, other application programs, such as an FTP server or a media server for streaming audio/video data to clients may also be running on a server 1210. In at least one embodiment, different servers may be dedicated to performing different tasks. In at least one embodiment, server 1210 may be a dedicated web server that manages resources relating to web sites for various users, whereas a server 1212 may be dedicated to provide electronic mail (email) management. In at least one embodiment, other servers may be dedicated for media (audio, video, etc.), file transfer protocol (FTP), or a combination of any two or more services that are typically available or provided over a network. In at least one embodiment, each server may be in a location that is the same as or different from that of other servers. In at least one embodiment, there may be multiple servers that perform mirrored tasks for users, thereby relieving congestion or minimizing traffic directed to and from a single server. In at least one embodiment, servers 1210, 1212, 1214 are under control of a web hosting provider in a business of maintaining and delivering third party content over a network 1208.

In at least one embodiment, web hosting providers deliver services to two different types of clients. In at least one embodiment, one type, which may be referred to as a browser, requests content from servers 1210, 1212, 1214 such as web pages, email messages, video clips, etc. In at least one embodiment, a second type, which may be referred to as a user, hires a web hosting provider to maintain a network resource such as a web site, and to make it available to browsers. In at least one embodiment, users contract with a web hosting provider to make memory space, processor capacity, and communication bandwidth available for their desired network resource in accordance with an amount of server resources a user desires to utilize.

In at least one embodiment, in order for a web hosting provider to provide services for both of these clients, application programs which manage a network resources hosted by servers must be properly configured. In at least one embodiment, program configuration process involves defining a set of parameters which control, at least in part, an application program's response to browser requests and which also define, at least in part, a server resources available to a particular user.

In one embodiment, an intranet server 1216 is in communication with a network 1208 via a communication link. In at least one embodiment, intranet server 1216 is in communication with a server manager 1218. In at least one embodiment, server manager 1218 comprises a database of an application program configuration parameters which are being utilized in servers 1210, 1212, 1214. In at least one embodiment, users modify a database 1220 via an intranet 1216, and a server manager 1218 interacts with servers 1210, 1212, 1214 to modify application program parameters so that they match a content of a database. In at least one embodiment, a user logs onto an intranet server 1216 by connecting to an intranet 1216 via computer 1202 and entering authentication information, such as a username and password.

In at least one embodiment, when a user wishes to sign up for new service or modify an existing service, an intranet server 1216 authenticates a user and provides a user with an interactive screen display/control panel that allows a user to access configuration parameters for a particular application program. In at least one embodiment, a user is presented with a number of modifiable text boxes that describe aspects of a configuration of a user's web site or other network resource. In at least one embodiment, if a user desires to increase memory space reserved on a server for its web site, a user is provided with a field in which a user specifies a desired memory space. In at least one embodiment, in response to receiving this information, an intranet server 1216 updates a database 1220. In at least one embodiment, server manager 1218 forwards this information to an appropriate server, and a new parameter is used during application program operation. In at least one embodiment, an intranet server 1216 is configured to provide users with access to configuration parameters of hosted network resources (e.g., web pages, email, FTP sites, media sites, etc.), for which a user has contracted with a web hosting service provider.

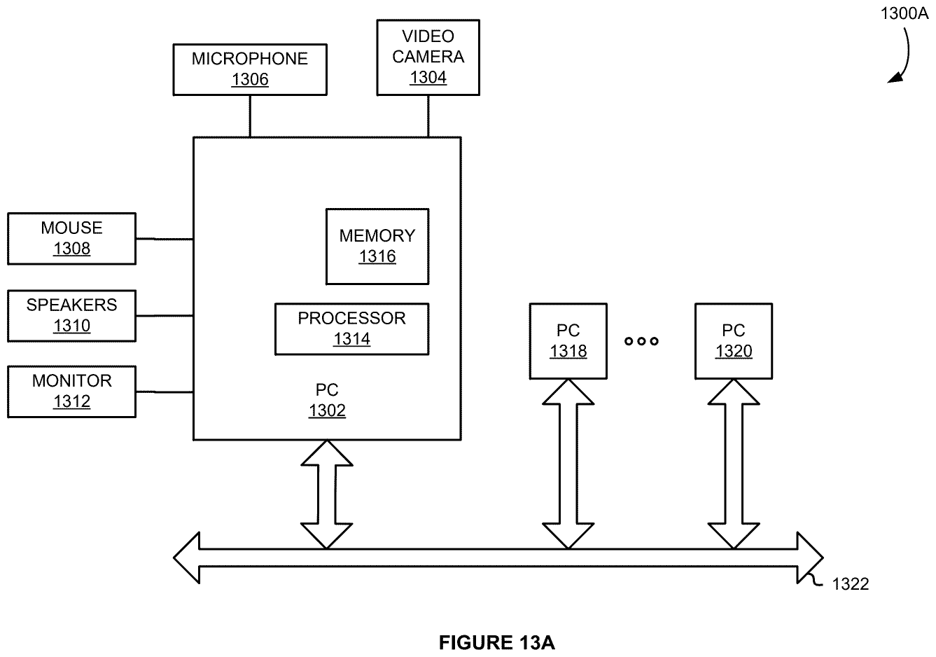

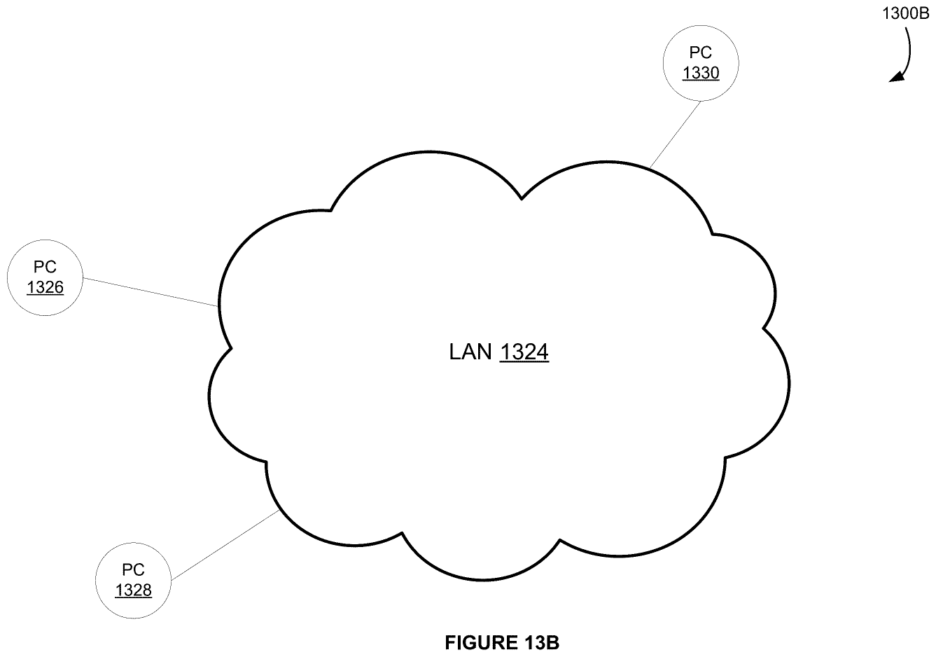

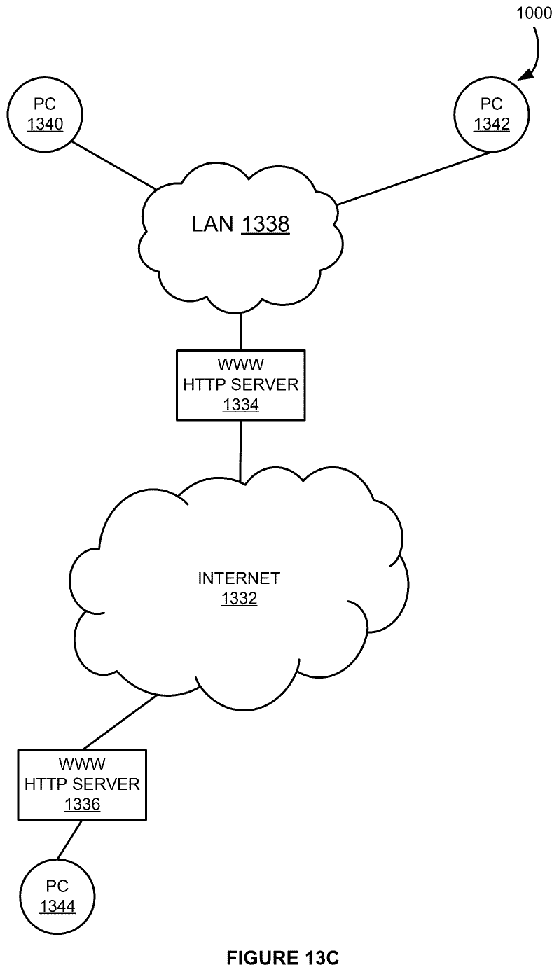

FIG. 13A illustrates a networked computer system 1300A, in accordance with at least at least one embodiment. In at least one embodiment, networked computer system 1300A comprises a plurality of nodes or personal computers (“PCs”) 1302, 1318, 1320. In at least one embodiment, personal computer or node 1302 comprises a processor 1314, memory 1316, video camera 1304, microphone 1306, mouse 1308, speakers 1310, and monitor 1312. In at least one embodiment, nodes 1302, 1318, 1320 may each run one or more desktop servers of an internal network within a given company, for instance, or may be servers of a general network not limited to a specific environment. In at least one embodiment, there is one server per node of a network, so that each node of a network represents a particular network server, having a particular network URL address. In at least one embodiment, each server defaults to a default web page for that server's user, which may itself contain embedded URLs pointing to further subpages of that user on that server, or to other servers or pages on other servers on a network.

In at least one embodiment, nodes 1302, 1318, 1320 and other nodes of a network are interconnected via medium 1322. In at least one embodiment, medium 1322 may be, a communication channel such as an Integrated Services Digital Network (“ISDN”). In at least one embodiment, various nodes of a networked computer system may be connected through a variety of communication media, including local area networks (“LANs”), plain-old telephone lines (“POTS”), sometimes referred to as public switched telephone networks (“PSTN”), and/or variations thereof. In at least one embodiment, various nodes of a network may also constitute computer system users inter-connected via a network such as the Internet. In at least one embodiment, each server on a network (running from a particular node of a network at a given instance) has a unique address or identification within a network, which may be specifiable in terms of an URL.

In at least one embodiment, a plurality of multi-point conferencing units (“MCUs”) may thus be utilized to transmit data to and from various nodes or “endpoints” of a conferencing system. In at least one embodiment, nodes and/or MCUs may be interconnected via an ISDN link or through a local area network (“LAN”), in addition to various other communications media such as nodes connected through the Internet. In at least one embodiment, nodes of a conferencing system may, in general, be connected directly to a communications medium such as a LAN or through an MCU, and that a conferencing system may comprise other nodes or elements such as routers, servers, and/or variations thereof.

In at least one embodiment, processor 1314 is a general-purpose programmable processor. In at least one embodiment, processors of nodes of networked computer system 1300A may also be special-purpose video processors. In at least one embodiment, various peripherals and components of a node such as those of node 1302 may vary from those of other nodes. In at least one embodiment, node 1318 and node 1320 may be configured identically to or differently than node 1302. In at least one embodiment, a node may be implemented on any suitable computer system in addition to PC systems.

FIG. 13B illustrates a networked computer system 1300B, in accordance with at least at least one embodiment. In at least one embodiment, system 1300B illustrates a network such as LAN 1324, which may be used to interconnect a variety of nodes that may communicate with each other. In at least one embodiment, attached to LAN 1324 are a plurality of nodes such as PC nodes 1326, 1328, 1330. In at least one embodiment, a node may also be connected to the LAN via a network server or other means. In at least one embodiment, system 1300B comprises other types of nodes or elements, for example including routers, servers, and nodes.

FIG. 13C illustrates a networked computer system 1300C, in accordance with at least at least one embodiment. In at least one embodiment, system 1300C illustrates a WWW system having communications across a backbone communications network such as Internet 1332, which may be used to interconnect a variety of nodes of a network. In at least one embodiment, WWW is a set of protocols operating on top of the Internet, and allows a graphical interface system to operate thereon for accessing information through the Internet. In at least one embodiment, attached to Internet 1332 in WWW are a plurality of nodes such as PCs 1140, 1342, 1344. In at least one embodiment, a node is interfaced to other nodes of WWW through a WWW HTTP server such as servers 1334, 1336. In at least one embodiment, PC 1344 may be a PC forming a node of network 1332 and itself running its server 1336, although PC 1344 and server 1336 are illustrated separately in FIG. 11C for illustrative purposes.

In at least one embodiment, WWW is a distributed type of application, characterized by WWW HTTP, WWW's protocol, which runs on top of the Internet's transmission control protocol/Internet protocol (“TCP/IP”). In at least one embodiment, WWW may thus be characterized by a set of protocols (i.e., HTTP) running on the Internet as its “backbone.”

In at least one embodiment, a web browser is an application running on a node of a network that, in WWW-compatible type network systems, allows users of a particular server or node to view such information and thus allows a user to search graphical and text-based files that are linked together using hypertext links that are embedded in documents or files available from servers on a network that understand HTTP. In at least one embodiment, when a given web page of a first server associated with a first node is retrieved by a user using another server on a network such as the Internet, a document retrieved may have various hypertext links embedded therein and a local copy of a page is created local to a retrieving user. In at least one embodiment, when a user clicks on a hypertext link, locally-stored information related to a selected hypertext link is typically sufficient to allow a user's machine to open a connection across the Internet to a server indicated by a hypertext link.

In at least one embodiment, more than one user may be coupled to each HTTP server, for example through a LAN such as LAN 1338 as illustrated with respect to WWW HTTP server 1334. In at least one embodiment, system 1300C may also comprise other types of nodes or elements. In at least one embodiment, a WWW HTTP server is an application running on a machine, such as a PC. In at least one embodiment, each user may be considered to have a unique “server,” as illustrated with respect to PC 1344. In at least one embodiment, a server may be considered to be a server such as WWW HTTP server 1334, which provides access to a network for a LAN or plurality of nodes or plurality of LANs. In at least one embodiment, there are a plurality of users, each having a desktop PC or node of a network, each desktop PC potentially establishing a server for a user thereof. In at least one embodiment, each server is associated with a particular network address or URL, which, when accessed, provides a default web page for that user. In at least one embodiment, a web page may contain further links (embedded URLs) pointing to further subpages of that user on that server, or to other servers on a network or to pages on other servers on a network.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, terms “system” and “method” are used herein interchangeably insofar as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a memory; and
at least one processing device, operatively coupled with the memory, to:
obtain at least a first quantum measurement associated with a qubit determined based on a first set of parameter values, and a second quantum measurement associated with the qubit determined based on a second set of parameter values; and
cause a ground state associated with the qubit to be estimated based on at least the first quantum measurement, the second quantum measurement, and at least one relationship between at least the first set of parameter values and the second set of parameter values.

2. The system of claim 1, wherein the at least one processing device comprises a network interface controller.

3. The system of claim 1, wherein:
the first quantum measurement is generated by a first quantum circuit that is constructed based on the first set of parameter values; and
the second quantum measurement is generated by a second quantum circuit that is constructed based on the second set of parameter values.

4. The system of claim 1, wherein, to cause the ground state of the qubit to be estimated, the at least one processing device is further to:
send at least the first quantum measurement to a first classical computer and the second quantum measurement to a second classical computer for parallel processing;
receive, from the first classical computer, a first set of updated parameter values;
receive, from the second classical computer, a second set of updated parameter values; and
determine a new set of parameter values based on the first set of updated parameter values, the second set of updated parameter values, and the at least one relationship between the first set of parameter values and the second set of parameter values.

5. The system of claim 4, wherein the at least one processing device is further to cause a quantum circuit to be constructed based on the new set of parameter values.

6. The system of claim 1, wherein the at least one processing device is further configured to:
determine whether a wave function associated with the ground state associated with the qubit satisfies a threshold condition; and
in response to determining that the wave function satisfies the threshold condition, complete a measurement of the qubit.

7. The system of claim 1, wherein the first set of parameter values comprises a first set of rotation angles, and wherein the second set of parameter values comprises a second set of rotation angles.

8. A method comprising:
obtaining, by at least one processing device, at least a first quantum measurement associated with a qubit determined based on a first set of parameter values, and a second quantum measurement associated with the qubit determined based on a second set of parameter values; and
causing, by the at least one processing device, a ground state associated with the qubit to be estimated based on at least the first quantum measurement, the second quantum measurement, and at least one relationship between at least the first set of parameter values and the second set of parameter values.

9. The method of claim 8, wherein the at least one processing device comprises a network interface controller.

10. The method of claim 8, wherein:
the first quantum measurement is generated by a first quantum circuit that is constructed based on the first set of parameter values; and
the second quantum measurement is generated by a second quantum circuit that is constructed based on the second set of parameter values.

11. The method of claim 8, wherein causing the state of the qubit to be estimated further comprises:
sending at least the first quantum measurement to a first classical computer and the second quantum measurement to a second classical computer for parallel processing;
receiving, from the first classical computer, a first set of updated parameter values;
receiving, from the second classical computer, a second set of updated parameter values; and
determining a new set of parameter values based on the first set of updated parameter values, the second set of updated parameter values, and the at least one relationship between the first set of parameter values and the second set of parameter values, wherein the new set of parameter values represents the ground state.

12. The method of claim 11, further comprising causing, by the at least one processing device, a quantum circuit to be constructed based on the new set of parameter values.

13. The method of claim 8, further comprising:
determining, by the at least one processing device, whether a wave function associated with the ground state associated with the qubit satisfies a threshold condition; and
in response to determining that the wave function satisfies the threshold condition, completing, by the at least one processing device, a measurement of the qubit.

14. The method of claim 8, wherein the first set of parameter values comprises a first set of rotation angles, and wherein the second set of parameter values comprises a second set of rotation angles.

15. A system comprising:
one or more quantum computers;
at least a first classical computer and a second classical computer; and
a network interface controller (NIC), operatively coupled with the one or more quantum computers and at least the first classical computer and the second classical computer, to:
obtain, from the one or more quantum computers, at least a first quantum measurement associated with a qubit determined based on a first set of parameter values, and a second quantum measurement associated with the qubit determined based on a second set of parameter values;
send at least the first quantum measurement and the second quantum measurement to at least a first classical computer and a second classical computer, respectively, to execute an optimization method in parallel to generate one or more sets of updated parameter values based on the first quantum measurement associated with the qubit and the second quantum measurement associated with the qubit;
receive, from at least the first classical computer and the second classical computer, the one or more sets of updated parameter values; and
cause a ground state associated with the qubit to be estimated, wherein, to cause the ground state associated with the qubit to be estimated, the NIC is further to determine a new set of parameter values based on the first set of updated parameter values and the second set of updated parameter values.

16. The system of claim 15, wherein the first quantum measurement associated with the qubit corresponds to a first set of expectation values of a first Hamiltonian determined based on the first set of parameter values, and wherein the second quantum measurement associated with the qubit corresponds to a second set of expectation values of a second Hamiltonian determined based on the second set of parameter values.

17. The system of claim 15, wherein the NIC is further to:
determine whether a wave function associated with the ground state associated with the qubit satisfies a threshold condition; and
in response to determining that the wave function satisfies the threshold condition, complete a measurement of the qubit.

18. The system of claim 15, wherein:
the one or more quantum computers implement at least a first quantum circuit constructed based on the first set of parameters to generate the first quantum measurement associated with the qubit, and a second quantum circuit constructed based on the second set of parameters to generate the second quantum measurement associated with the qubit; and
the NIC is further to cause accuracy of quantum measurements made by at least the first quantum circuit and the second quantum circuit to be determined.

19. The system of claim 18, wherein the NIC is further to cause at least a third quantum circuit to be constructed based on the new set of parameter values.

20. The system of claim 15, wherein the first set of parameter values comprises a first set of rotation angles, and wherein the second set of parameter values comprises a second set of rotation angles.
